(19) United States
(12) Patent Application Publication
(10) Pub. No.: US 2013/0240555 A1
(43) Pub. Date: Sep. 19, 2013

(54) TABLET CASSETTE OF MEDICINE PACKING APPARATUS, AND METHOD OF OPERATING THE SAME

(71) Applicant: Ho Yeon Kim, Anyang-si (KR)

(72) Inventor: Ho Yeon Kim, Anyang-si (KR)

(21) Appl. No.: 13/989,559

(22) PCT Filed: Nov. 24, 2011
(86) PCT No.: PCT/KR2011/009020

§ 371 Date: May 24, 2013

(30) Foreign Application Priority Data
Nov. 26, 2010 (KR) 10-2010-0119162

(51) Int. Cl. B65G 47/14; G07F 11/00; B65H 7/00

(52) U.S. Cl. CPC B67D 7/00
USPC 221/1; 221/17; 221/200

(57) ABSTRACT

A tablet cassette of a medicine packing apparatus capable of sensing the tablet congestion occurred inside the tablet cassette and settling the congestion and a method for operating the same are provided. The tablet cassette includes a cartridge having space for containing tablets and an outlet for discharging the tablets, a tablet installation unit, and an oscillator vibrating the cartridge when tablets may not be discharged even if they are remained inside the cartridge.

### TECHNICAL FIELD

Embodiments relates to a medicine packing apparatus packing tablets such as capsules in each dose, and more particularly, to a tablet cassette which is installed in the medicine packing apparatus containing a plurality of tablets and discharge the tablets according to a prescription, and a method for operating the same.

### BACKGROUND ART

A medicine packing apparatus is an apparatus for discharging tablets prescribed according to the illness of a patient and packing the tablets in each dose automatically. The medicine packing apparatus includes an installation unit on which pluralities of tablet cassettes are mounted and a hopper disposed below the installation unit. Each of the tablet cassettes contains each different kind of tablet.

The tablets are discharged from each of the tablet cassettes that are controllable and then assembled in the hopper. And the tablets assembled in the hopper are discharged down the hopper and packed with sealed in a packing paper.

The tablet cassette contains a single kind of tablets and is designed to discharge by one tablet. However, various factors may be occurred on the path that tablets flow from inside of the cassette to the outside of the cassette, therefore, the path may be congested instead of discharging according to a prescription.

Figuring out the congestion in the tablet cassette manually and correcting the error manually may worsen productivity of tablet medicine packing work. Also, if the packing work is continued without sensing the congestion in the tablet cassette, the whole process of the tablet medicine packing work may become an error, thereby threatening patient's health.

### DETAILED DESCRIPTION OF THE INVENTION

### Technical Goal of the Invention

The inventive concept provides a tablet cassette of medicine packing apparatus capable of settling congestion easily when tablet cassette congestion occurs.

The inventive concept also provides a method for operating the tablet cassette of a medicine packing apparatus capable of sensing and settling the congestion when tablet cassette congestion occurs.

### Technical Solution of the Invention

According to an exemplary embodiment of the inventive concept, a tablet cassette of a medicine packing apparatus includes a cartridge, a cartridge installation unit, and an oscillator. The cartridge includes a space for containing tablets and an outlet for discharging the tablets. The cartridge is loaded on the cartridge installation unit. The oscillator vibrates the cartridge when the cartridge may not discharge a tablet even though there remain tablets therein.

The oscillator may be inserted to an oscillator installation groove formed on the bottom of the cartridge.

According to an exemplary embodiment of the inventive concept, a method for operating a tablet cassette of a medicine packing apparatus including space for containing tablets, a cartridge having an outlet for discharging the tablets, a cartridge installation unit loading the cartridge, and an oscillator vibrating the cartridge is provided. The method for controlling the tablet cassette of a medicine tablet packing apparatus includes tablet discharging operating the tablet outlet. The method also includes tablet discharging realization determining whether the tablets are really discharged or not. The method includes determining remaining tablets determining whether there is a remaining tablet inside the cassette or not when it is determined that a tablet is not discharged to the outside. The method includes vibrating the cartridge by inputting an electric signal to the oscillator when it is determined that there is a remaining tablet inside the cassette.

The determining remaining tablets includes counting the number of tablets provided to the cartridge, counting the number of tablets discharged outside, and calculating a difference between the number of tablets provided to the cartridge and the number of tablets discharged outside.

### Effect of the Invention

A tablet cassette according to an exemplary embodiment of the inventive concept and a method for operating the same make it possible to sense congestion of discharging tablets contained inside the tablet cassette easily and react properly, thereby increasing productivity of tablet medicine packing operation and preventing from threat on patients' health.

### BRIEF DESCRIPTION OF THE DRAWINGS

Exemplary embodiments of the inventive concept will be more clearly understood from the following detailed description taken in conjunction with the accompanying drawings in which:

FIG. 1 is a cross-sectional view of a tablet cassette of a medicine packing apparatus according to an exemplary embodiment of the inventive concept;

FIG. 2 is an exploded perspective view of a tablet cassette of a medicine packing apparatus according to an exemplary embodiment of the inventive concept;

FIG. 3 is a diagram illustrating the bottom of a cartridge shown in FIG. 2; and

FIG. 4 is a flow chart illustrating a method for operating a tablet cassette of a medicine packing apparatus according to an exemplary embodiment of the inventive concept.

### BEST MODE FOR CARRYING OUT THE INVENTION

Various example embodiments will be described more fully hereinafter with reference to the accompanying drawings, in which some example embodiments are shown. Inventive concepts may, however, be embodied in many different forms and should not be construed as limited to the example embodiments set forth herein. Rather, example embodiments are provided so that this disclosure will be thorough and complete, and will fully convey the scope of inventive concepts to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the inventive concepts. As used herein, the term “and/or” includes any and all combinations of one or more of the associated listed items.

It will be understood that when an element is referred to as being “connected” or “paired” to another element, it can be directly connected or paired to the other element or intervening elements may be present. In contrast, when an element is referred to as being “directly connected” or “directly paired” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

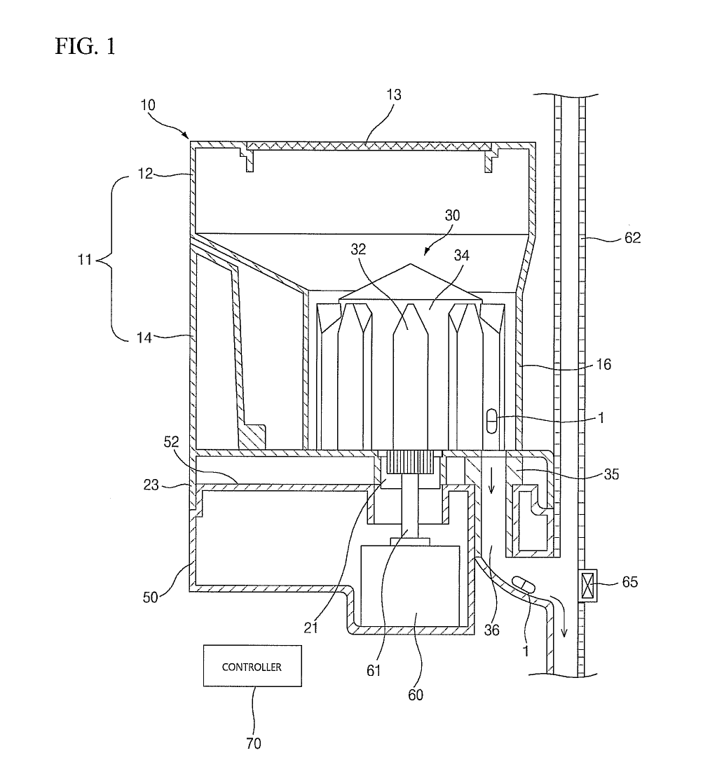

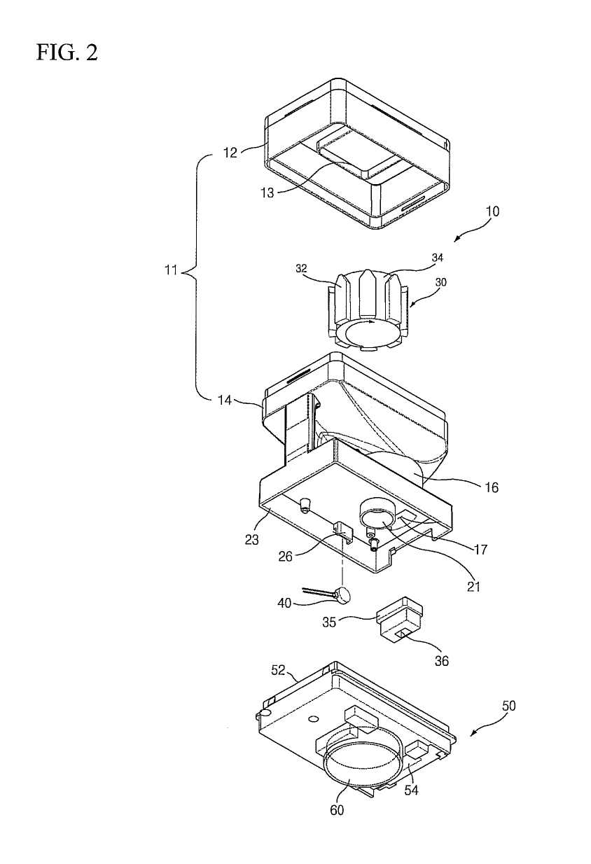

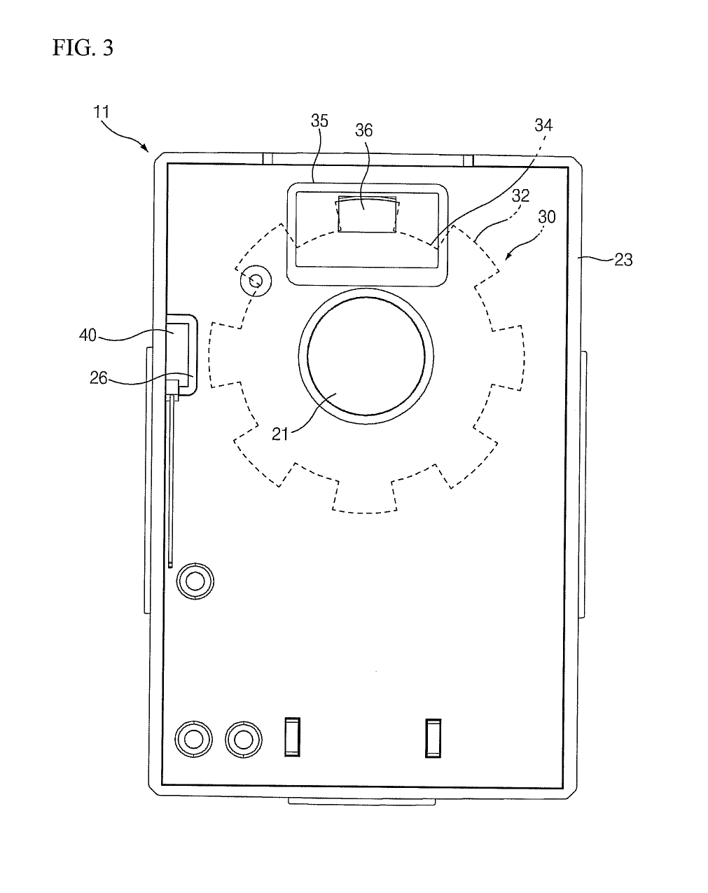

FIG. 1 is a cross-sectional view of a tablet cassette of a medicine packing apparatus according to an exemplary embodiment of the inventive concept, and FIG. 2 is an exploded perspective view of a tablet cassette of a medicine packing apparatus according to an exemplary embodiment of the inventive concept, and FIG. 3 is a diagram illustrating the bottom of a cartridge of FIG. 2.

A plurality of the tablet cassettes 10 shown in FIGS. 1 and 2 are disposed on the upper body of a medicine packing apparatus (not shown). Each of the tablet cassettes contains a different kind of table medicines. A hopper (not shown) is prepared beneath the tablet cassettes, where tablets discharged from the tablet cassettes are assembled. A packing unit (not shown) for packing tablets discharged through the hopper in packing paper is prepared below the hopper.

Referring to FIGS. 1 through 3, the tablet cassette 10 includes a cartridge 11 for containing tablets, a cartridge installation unit 50 on which the cartridge 11 is loaded detachably, a tablet guide block 35, and a drum 30.

The cartridge 11 includes an upper housing 12 with a lid 13 and a lower housing 14. Interior space for containing tablets is formed by combining the upper housing 12 and the lower housing 14.

The bottom of the lower housing 14 includes a tablet outlet 17 opened to discharge tablets contained inside the cartridge 11 to the outside.

The tablet guide block 35 is combined beneath the tablet outlet 17. The tablet guide block 35 includes a tablet discharge path 36. The tablet guide block 35 is inserted to a block accepting through hole on the cartridge installation unit 50 when the cartridge 11 is installed on the cartridge installation unit 50.

Tablets 1 inside the cartridge 11 go through the tablet outlet 17 and the tablet discharge path 36. Thereafter the tablets 1 are discharged below the tablet cassette 10 by one tablet or the required number of tablets. Thereafter the tablets 1 are transferred through a tablet transfer path 62, and assembled in the hopper (not shown).

A throat 16 is formed on the tablet outlet 17 and the drum 30 is inserted therein rotatably. The drum 30 is a discharging device for discharging the tablet 1 to the outside of the cartridge 11 by one tablet.

The drum 30 includes projections 32 on the outer circumference surface and guide grooves 34. The projections 32 are protruded from the outer circumference surface by certain intervals, and guide grooves 34 are extended below between an adjacent pair of projections 32. Tablets received inside the throat 16 flow into each guide groove 34 in a row by self-weight. Accordingly, whenever the drum 30 rotates by the angle between the adjacent two projections 32 at a predetermined speed, the tablet 1 is discharged outside of the tablet cassette 10 through the tablet outlet 17 and the tablet discharge path 36 and arrives to the hopper (not shown).

A motor 60 providing rotation driving power to the drum 30 is installed on the cartridge installation unit 50, and a motor connection through hole 21 is formed on the bottom of the lower housing 14 of the cartridge 11 such that a pivot 61 of the motor 60 may be inserted. The pivot 61 of the motor 60 is connected to the drum 30 through the motor connection through hole 21 so as to transfer power, when the cartridge 11 is mounted on the cartridge installation unit 50.

An array wall 23 protruding below is formed on the perimeter of the bottom of the lower housing 14, and protrusions 52 are formed on the upper side of the cartridge installation unit 50, such that the cartridge 11 may be installed in the accurate position when being mounted on the cartridge installation unit 50.

The protrusions 52 are inserted into the space of the bottom of the lower housing 14 which is formed by the array wall 23 by sliding by the inner surface of the array wall 23.

Referring to FIGS. 2 and 3, the tablet cassette 10 includes an oscillator 40. The oscillator 40 vibrates the cartridge 11 when the tablet 1 may not be discharged even though the tablet 1 is still inside the cartridge 11.

At this time, an oscillator installation groove 26 is prepared on the bottom of the lower housing 14 and the oscillator 40 is inserted therein. A circuit substrate including a driving circuit for driving the oscillator 40 is formed on the bottom of the lower housing 14, although it is not shown. The oscillator 40 may be the same one as the oscillator for embodying a vibration mode in a cell phone.

The oscillator 40 is inserted to the oscillator installation groove 26. Accordingly, the oscillator 40 contacts the array wall 23 of the lower housing 14 such that the cartridge 11 vibrates with the vibration of the oscillator 40.

Referring to FIGS. 1 and 2 again, a sensor 65 is prepared in the tablet transfer path 62 to sense whether the tablet 1 is really discharged from the tablet cassette 10 or not. Also, the medicine packing apparatus (not shown) includes a controller 70 controlling the motor 60 such that the tablet 1 is discharged according to the prescription and controlling the oscillator 40 based on a sensing signal of the sensor 65.

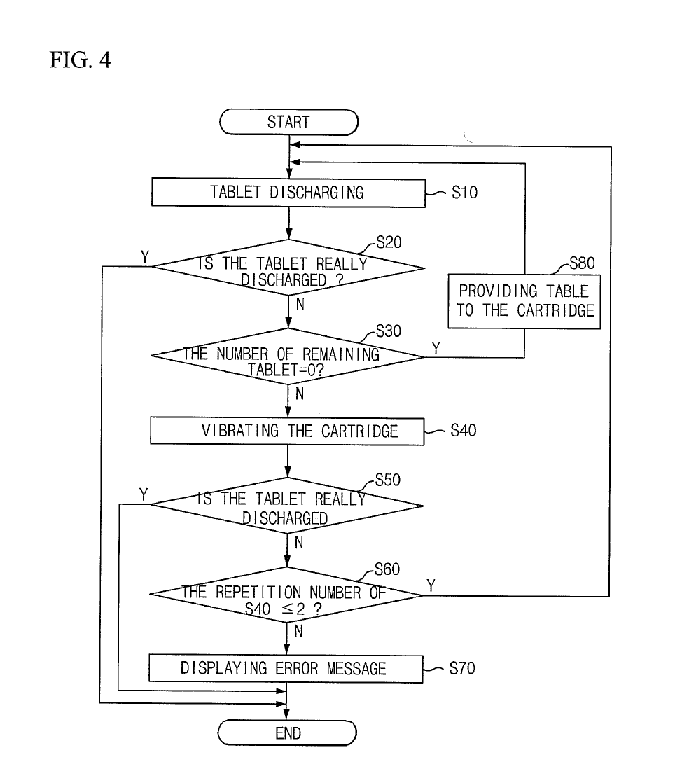

FIG. 4 is a flow chart illustrating a method for operating the tablet cassette 10 of a medicine packing apparatus shown in FIGS. 1 and 2. Specifically, the method of FIG. 4 is for sensing and discharging the tablet 1, when the tablet 1 fails to be discharged smoothly, which may be performed automatically under the control of the controller 70.

Referring to FIGS. 1 through 4, the method for operating the tablet cassette 10 includes operating tablet discharge S10, determining realization of tablet discharge S20, determining the number of remaining tablets S30, and vibrating the cartridge S40.

In the stage S10, driving the motor 60 according to a prescription and rotating the drum 30.

In the stage S20, determining whether the tablet 1 is discharged to the outside of the cassette 10 by the rotation of the drum 30. The sensor 65 performs sensing whether the tablet 1 is really discharged to the outside of the cassette 10 or not.

The controller 70 determines whether the tablet 1 is actually discharged or not based on a sensing signal received from the sensor 65. Once it is determined that the tablet 1 is actually discharged, the operation of the tablet cassette 10 is finished.

The reason that the tablet 1 may not be discharged despite of the rotation of the drum 30 is that either all of the tablets 1 contained in the cartridge 11 are discharged, or the tablet 1 is tied up inside the cartridge. In the stage S30, determining whether there is remaining tablet 1 inside the cartridge or not, if the tablet 1 is not determined to be actually discharged in the stage S20.

The number of remaining tablets 1 may be determined through counting the number of provided tablets and counting the number of discharged tablets, and calculating the difference, in the stage of determining remaining tablets S30.

The counting the number of provided tablets counts the number of tablets 1 provided in the cartridge. The counting the number of discharged tablets counts the number of tablets 1 discharged to the outside of the tablet cassette 10. The calculating the difference calculates the difference between the number of provided tablets and the number of discharged tablets.

The number of tablets 1 provided to the cartridge 11 may be obtained by counting the tablets 1 before opening the lid 13 and putting the tablets 1 into the cartridge 11. An operator may count the tablets one by one, and a tablet counter may be used to count the tablets. The number of tablets 1 provided to the cartridge 11 may be input by an input device such as a keyboard (not shown) such that the controller 70 may recognize the number.

The number of tablets 1 discharged to the outside of the tablet cassette 10 may be obtained by sensing tablets 1 passing through the tablet transfer path 62, transferring sensing signals to the controller 70, and counting the number of the sensing signals by the controller 70. Calculating the difference between the number of provided tablets and the number of discharged tablets may be also performed by the controller 70.

When it is determined that the number of remaining tablet is zero in the stage S30, providing tablets 1 to the cartridge 11 S80, and rotating the drum 30 to restart the stage S10.

In the stage S40, vibrating the cartridge 11 on purpose by driving the oscillator 40 when it is determined that there are remaining tablets in the determining remaining tablets S30. After the stage S40, determining whether the remaining tablet 1 is really discharged or not is performed again S50, and once it is determined that the tablet 1 is discharged, the operation of the tablet cassette 10 is finished.

As described above, the sensor 65 performs sensing whether the tablet 1 is really discharged to the outside of the tablet cassette 10 or not. When a signal of the sensor 65 is transferred to the controller 70, the controller 70 determines whether the tablet 1 is discharged or not based on the sensing signal.

When it is determined that the tablet 1 is not still discharged to the outside of the tablet cassette 10, determining that the number of performing the vibrating the cartridge S40 is within two. If it is determined that the number of performing the vibrating the cartridge S40 is within 2 S60, the tablet discharge operation S10 is repeated by rotating the drum 30. However, if it is determined that the number of performing the vibrating the cartridge S40 is above 2, that is, 3, an error message is displayed on a display device (not shown) such as a flat display panel, and the operation of the tablet cassette 10 is finished S60. That is why it is determined that the tablet 1 may not be discharged to the outside of the tablet cassette 10 just with vibrating the tablet cassette 10.

It is an example that setting a base of the repetition number of performing the vibrating the cartridge as 2 in the stage S60, and it may be set as 3, 4, and so on.

While the present invention has been particularly shown and described with reference to exemplary embodiments thereof, it will be understood that various changes in form and details may be made therein without departing from the spirit and scope of the following claims.

### INDUSTRIAL USABILITY

The present invention is applicable to a medicine packing apparatus packing tablets by a dose automatically at hospitals, pharmacies, home, or the like.

What is claimed is:

1. A cassette of a medicine packing apparatus comprising:
a cartridge including space for containing tablets and a tablet outlet outlet for discharging the tablets;
a cartridge installation unit loading the cartridge; and
an oscillator vibrating the cartridge when a tablet may not be discharged even if there are remaining tablets inside the cartridge.

2. The cassette of claim 1, the oscillator is inserted to an oscillator installation groove formed on the bottom of the cartridge.

3. A method for operating a tablet cassette of a medicine packing apparatus comprising a cartridge including space for containing tablets and a tablet outlet, a cartridge installation unit, and an oscillator vibrating the cartridge includes:
operating the tablet outlet;
determining the tablets are really discharged by the tablet discharging operation;
determining whether there are remaining tablets inside the tablet cassette or not, when it is determined that a tablet is not discharged to the outside of the tablet cassette; and
vibrating the cartridge by inputting an electric signal to the oscillator, when it is determined there are remaining tablets inside the tablet cassette.

4. The method of claim 3, wherein the determining remaining tablets includes;
counting the number of tablets provided to the cartridge;
counting the number of tablets discharged to the outside of the tablet cassette; and
calculating the difference between the number of provided tablets and the number of discharged tablets.
